(19) United States
(12) Patent Application Publication
(10) Pub. No.: US 2024/0095804 A1
(43) Pub. Date: Mar. 21, 2024

(54) RESOLVING POTENTIAL LOSS OF SALES

(71) Applicant: International Business Machines Corporation, Armonk, NY (US)

(72) Inventors: Satisha C Honnavalli, Bangalore (IN); Bharat Sarjerao Khade, Bangalore (IN); Sai Nikhil Javvaji, Dhone (IN); Raghuveer Prasad Nagar, Kota (IN)

(21) Appl. No.: 17/933,908

(22) Filed: Sep. 21, 2022

(51) Int. Cl. G06Q 30/06; G06Q 30/02

(52) U.S. Cl. CPC G06Q 30/0631; G06Q 30/0201; G06Q 30/0207

(57) ABSTRACT

A computer-implemented method for resolving a potential loss of sale, is disclosed. The computer-implemented method includes determining a potential lost sale and an item associated with the potential lost sale. The computer-implemented method further includes determining a reason for the potential lost sale of the item. The computer-implemented method further includes determining one or more substitute items for the item based, at least in part, on the determined reason for the potential lost sale of the item. The computer-implemented method further includes presenting the one or more determined substitute items to a user.

### BACKGROUND

The present invention relates generally to the field of consumer channels of retail commerce, and more particularly to, consumer channels of commerce and recovering lost sales.

Retail or commerce includes the activity of buying and selling. Buying and selling can be performed in a physical shop or online with an electronic commerce platform or website. E-commerce (electronic commerce) is the buying and selling of goods and services, or the transmitting of funds or data, over an electronic network, primarily the internet.

### SUMMARY

According to one embodiment of the present invention, a computer-implemented method for resolving a potential loss of sale, is disclosed. The computer-implemented method includes determining a potential lost sale and an item associated with the potential lost sale. The computer-implemented method further includes determining a reason for the potential lost sale of the item. The computer-implemented method further includes determining one or more substitute items for the item based, at least in part, on the determined reason for the potential lost sale of the item. The computer-implemented method further includes presenting the one or more determined substitute items to a user.

According to another embodiment of the present invention, a computer program product for resolving a potential loss of sale, is disclosed. The computer program product includes one or more computer readable storage media and program instructions stored on the one or more computer readable storage media. The program instructions include instructions to determine a potential lost sale and an item associated with the potential lost sale. The program instructions further include instructions to determine a reason for the potential lost sale of the item. The program instructions further include instructions to determine one or more substitute items for the item based, at least in part, on the determined reason for the potential lost sale of the item. The program instructions further include instructions to present the one or more determined substitute items to a user.

According to another embodiment of the present invention, a computer system for resolving a potential loss of sale, is disclosed. The computer system includes one or more computer processors, one or more computer readable storage media, and computer program instructions, the computer program instructions being stored on the one or more computer readable storage media for execution by the one or more computer processors. The program instructions include instructions to determine a potential lost sale and an item associated with the potential lost sale. The program instructions further include instructions to determine a reason for the potential lost sale of the item. The program instructions further include instructions to determine one or more substitute items for the item based, at least in part, on the determined reason for the potential lost sale of the item. The program instructions further include instructions to present the one or more determined substitute items to a user.

### BRIEF DESCRIPTION OF DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a functional block diagram of computing environment, generally designated 100, suitable for the execution of at least some of the computer code involved in performing the inventive methods, such as new potential sales recovery code 150, in accordance with at least one embodiment of the present invention.

FIG. 2 is a functional block diagram of an exemplary loss of sale system, generally designated 200, suitable for operation of a sale recovery program 201, in accordance with at least one embodiment of the present invention.

FIG. 3 is a flow chart diagram depicting operational steps for sale recovery program 201, generally designated 300, in accordance with at least one embodiment of the present invention.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

The present invention relates generally to the field of channels of retail commerce, and more particularly to, recovering lost sales over different channels of retail commerce.

With the prevalence and popularity of online shopping, it is very common for people to shop on ecommerce marketplaces. At the same time, customers shop at physical stores as they could easily influence customers to purchase more and more. Many customers shop and visit many various consumer channels of commerce such as online shopping, specific store applications, and physical stores. There has always been lost sales due to various reasons, such as inventory not being available, competitive prices, not enough product varieties, delayed delivery, etc. Many times, such customers come in contact with the seller again. In such cases, the consumer channel could be different from the consumer channel on which the sale was lost. For example, a customer may have tried to buy item A on a website, but item A was not available for purchase due to a lack of current inventory. Later, the customer may visit the store to buy item A or some other item. In this example, the “online” website sales channel is different from the “in-store” sales channel.

Embodiments of the invention recognize the need to recover lost sale in subsequent or future transactions with the customer even when the sales transaction happens on a different sales channel. Embodiments of the present invention recover the sales lost in previous transactions with the customer by identifying the reasons for the lost sale in future transactions with the customer, and then, accordingly presenting a shopping option for the item associated with the previous failed sales transaction. Embodiments of the invention recognize the sales channels of contact can be different. Such as, the consumer was shopping at a brick and mortar store for a particular item, and because the particular item was not currently available, the customer subsequently went on the stores online shopping application later that day looking for the same item. Embodiments of the invention determine a sale is lost, meaning the consumer shopped for but did not purchase an item, based, at least in part, on one or more of user browsing history, search history, online orders, order cancellations, gestures, in-store activities, purchase history, electronic communications, and verbal communications. Embodiments of the present invention determine the causation of a lost sale. For example, a causation of a lost sale can include inventory shortage, shipping restrictions or delays, price, substitution preferences, lack of payment options, accidental logout, or someone else purchasing the item for the use of the consumer.

Embodiments of the invention determine a sale or discount for a proposed item in order to compensate for the loss of sale. For example, an embodiment of the invention determines a sale was lost for a storage bin and determines there is a 10% off coupon for a similar storage bin. Embodiments of the invention recognize consumers utilize AR devices and display shopping options to a user view the AR device. Embodiments of the invention present shopping options of the same item or a related item, such as a different brand or a variant item, such as a shirt in a different color.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

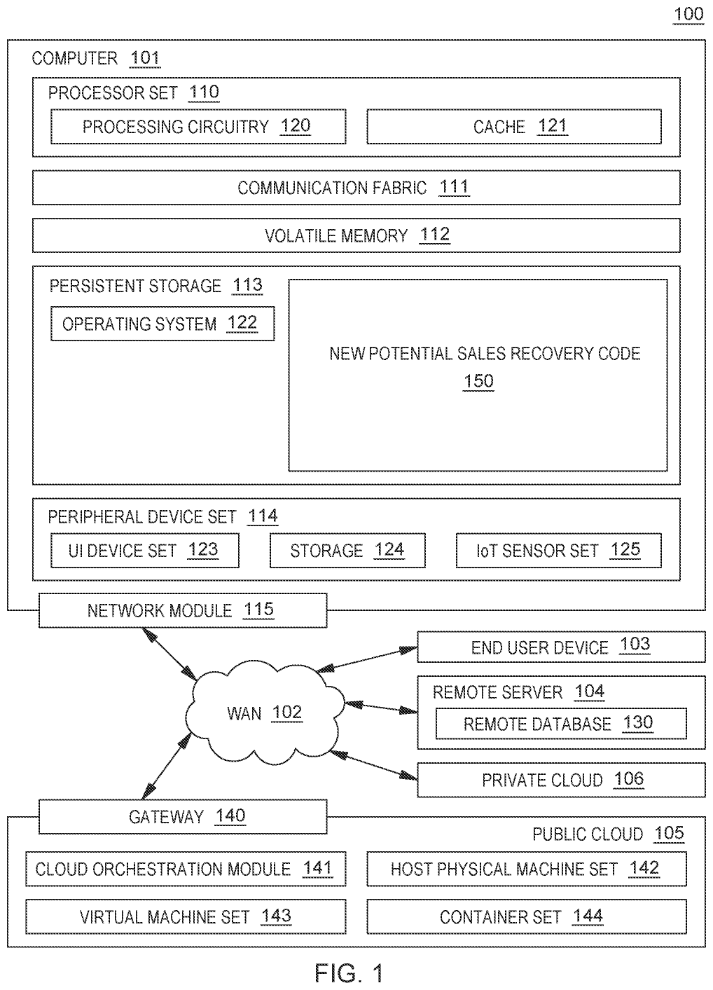

The present invention will now be described in detail with reference to the Figures. FIG. 1 is a functional block diagram of computing environment, generally designated 100, suitable for the execution of at least some of the computer code involved in performing the inventive methods, such as new potential sales recovery code 150, in accordance with at least one embodiment of the present invention. In addition to new potential sales recovery code 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and new potential sales recovery code 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in new potential sales recovery code 150 in persistent storage 113.

Communication Fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile Memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in new potential sales recovery code 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

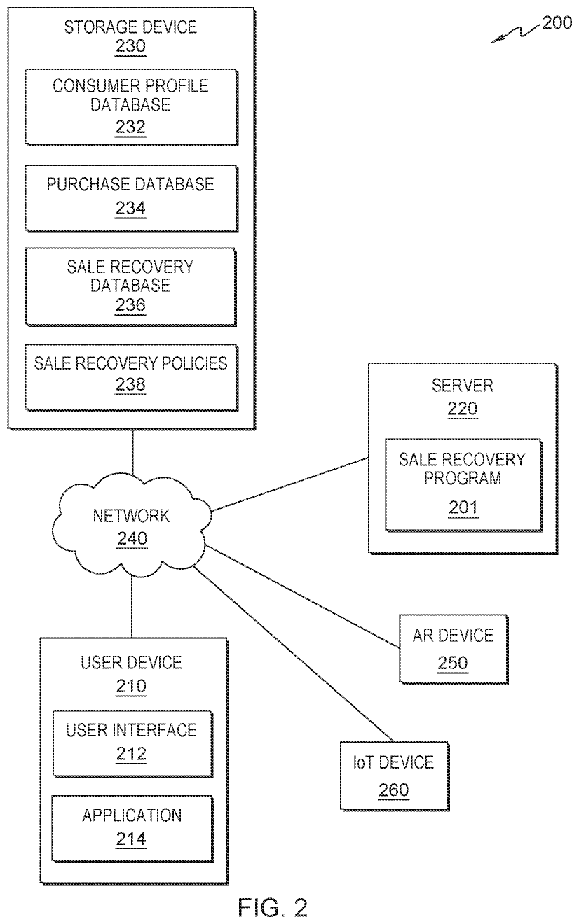

FIG. 2 is a functional block diagram of an exemplary loss of sale system, generally designated 200, suitable for operation of sale recovery program 201, in accordance with at least one embodiment of the present invention. Loss of sale system 200 may be implemented in a computing environment, such as computing environment 100, as described with reference to FIG. 1. FIG. 2 provides an illustration of only one implementation and does not imply any limitations with regard to the environments in which different embodiments may be implemented. Many modifications to the depicted environment may be made by those skilled in the art without departing from the scope of the present invention as recited by the claims.

Loss of sale system 200 includes user device 210, server 220, and storage device 230 interconnected over network 240. In general, user device 210 can represent any programmable electronic device or combination of programmable electronic devices capable of executing machine readable program instructions and communicating with server 220, storage device 230 and other devices (not depicted) via a network, such as network 240. In an embodiment, user device is an end user device, such as EDU 103 depicted in FIG. 1, and can be a mobile device, laptop computer, a tablet computer, a netbook computer, a personal computer, a desktop computer, a personal digital assistant (PDA), a smart phone, a wearable device (e.g., smart glasses, smart watches, e-textiles, AR headsets, etc.), or any programmable computer systems known in the art.

User device 210 further includes user interface 212 and application 214. User interface 212 is a program that provides an interface between a user of an end user device, such as user device 210, and a plurality of applications that reside on the device (e.g., application 214). A user interface, such as user interface 212, refers to the information (such as graphic, text, and sound) that a program presents to a user, and the control sequences the user employs to control the program. A variety of types of user interfaces exist. In one embodiment, user interface 212 is a graphical user interface. A graphical user interface (GUI) is a type of user interface that allows users to interact with electronic devices, such as a computer keyboard and mouse, through graphical icons and visual indicators, such as secondary notation, as opposed to text-based interfaces, typed command labels, or text navigation. In computing, GUIs were introduced in reaction to the perceived steep learning curve of command-line interfaces which require commands to be typed on the keyboard. The actions in GUIs are often performed through direct manipulation of the graphical elements. In another embodiment, user interface 212 is a script or application programming interface (API). In an embodiment, a consumer utilizes user device 210 to access a store website via a mobile application, such as application 214.

Application 214 can be representative of one or more applications (e.g., an application suite) that operate on user device 210. In an embodiment, application 214 is representative of one or more applications (e.g., social media applications, web conferencing applications, and email applications) located on user device 210. In various example embodiments, application 214 can be an application that a user of user device 210 utilizes to access a consumer website or store application to browse and purchase consumer goods. In an embodiment, application 214 can be a client-side application associated with a server-side application running on server 220 (e.g., a client-side application associated with sale recovery program 201). In an embodiment, application 214 can operate to perform processing steps of sale recovery program 201 (i.e., application 214 can be representative of sale recovery program 201 operating on user device 210).

Server 220 is configured to provide resources to various computing devices, such as user device 210. In general, server 220 represents any programmable electronic device or combination of programmable electronic devices capable of executing machine readable program instructions and communicating with each other, as well as with user device 210, storage device 230, and other computing devices (not shown) within a network, such as WAN 102 via a network, such as network 240. In an embodiment, server 220 is a standalone device, such as computer 101 depicted in FIG. 1, that is capable of running a program and accessing a network or querying a database. In an embodiment, server 220 can be a management server, a web server, an application server, a mobile device, or any other electronic device or computing system capable of receiving, sending, and processing data. In an embodiment, server 220 represents a server computing system utilizing multiple computers as a server system. In an embodiment, server 220 represents a computing system utilizing clustered computers and components (e.g., database server computer, application server computer, web server computer, webmail server computer, media server computer, etc.) that act as a single pool of seamless resources.

In various embodiments, storage device 230 is a secure data repository for persistently storing user and sales information utilized by various applications and user devices of a user, such as application 214 and user device 210. In an embodiment, storage device 230 is representative of one or more databases, such as remote database 130 depicted in FIG. 1. In an embodiment, storage device 230 includes consumer profile database 232, purchase database 234, and sale recovery database 236. Storage device 230 may be implemented using any volatile or non-volatile storage media known in the art for storing data. For example, storage device 230 may be implemented with a tape library, optical library, one or more independent hard disk drives, multiple hard disk drives in a redundant array of independent disks (RAID), solid-state drives (SSD), random-access memory (RAM), and any possible combination thereof. Similarly, storage device 230 may be implemented with any suitable storage architecture known in the art, such as a relational database, an object-oriented database, or one or more tables.

In an embodiment, sale recovery program 201 may be configured to access various data sources, such as consumer profile database 232, purchase database 234, sale recovery database 236, and sale recovery policies 238, that may include personal data, content, contextual data, or information that a user does not want to be processed. Personal data includes personally identifying information or sensitive personal information as well as user information, such as location tracking or geolocation information. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. In an embodiment, sale recovery program 201 enables the authorized and secure processing of personal data. In an embodiment, sale recovery program 201 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. In an embodiment, sale recovery program 201 provides information regarding personal data and the nature (e.g., type, scope, purpose, duration, etc.) of the processing. In an embodiment, sale recovery program 201 provides a user with copies of stored personal data. In an embodiment, sale recovery program 201 allows for the correction or completion of incorrect or incomplete personal data. In an embodiment, sale recovery program 201 allows for the immediate deletion of personal data.

In an embodiment, consumer profile database 232 includes information about consumers, consumer shopping preferences, and consumer primary or frequently purchased items. In an embodiment, consumer profile database 232 includes information on what types of products or brands a consumer purchases. For example, consumer profile database 232 includes information that user A prefers brand B over brand C for toothpaste. In an embodiment, sale recovery program 201 receives user input with consumer preference information and stores this information in consumer profile database 232. In an embodiment, sale recovery program 201 determines consumer preferences based on a consumer's transaction history. In an embodiment, sale recovery program 201 accesses purchase database 234 to determine consumer preferences from recently or historically purchased items and stores this information in consumer profile database 232. In an embodiment, sale recovery program 201 determines primary or frequently purchased items, wherein primary items include items or brands the consumer frequently purchases or an item the consumer is currently attempting to purchase. For example, if a user is online shopping for a camera and does not purchase a camera, a camera becomes a primary item. In an embodiment, consumer profile database 232 includes personal information about a consumer. In an embodiment, consumer profile database 232 includes calendar information associated with a consumer, such as birthdays, holidays, meetings, or events. For example, consumer profile database 232 includes information on the date, time, and theme of an upcoming birthday party user A is hosting for their child. In an embodiment, consumer profile database 232 includes information on multiple consumers. In an embodiment, consumer profile database 232 includes information on a primary consumer. In an embodiment, the primary consumer is the primary shopper for one or more other users. For example, a primary shopper does the majority of the shopping for a household or group of other users. In an embodiment, consumer profile database 232 includes information on a primary consumer and secondary consumers who reside with the primary consumer. For example, consumer profile database 232 includes information that user A and user B live together or that user A is a primary consumer and that user B and user C, user A's children, are secondary consumers.

In an embodiment, purchase database 234 includes information on purchases. In an embodiment, purchase database 234 includes information on previous purchases and the consumer channel of the purchase. For example, user A purchases brand B soap from physical store C and, sale recovery program 201 stores the information of the purchase such as the product, brand, consumer channel of sale, store, price, and time of purchase in purchase database 234. In an embodiment, sale recovery program 201 determines an item was purchased based, at least in part, on one or more of, but not limited to, browsing history, search history, online orders, order history, bank statement, gestures, in-store activities, purchase history, electronic communications, calendar entry, social media posting, verbal communication. For example, sale recovery program 201 determines a charge on user's credit card statement labeled “Shoe Store—ONLINE $20” and determines the user bought a pair of shoes online from “Shoe Store.” In an embodiment, sale recovery program 201 analyzes audio or video data via one or more IoT devices to determine the users speech or movement. In another example, sale recovery program 201 determines that a user verbally communicated to a store employee that the user wants to buy bread and sale recovery program 201 determines the user physically hands the store employee cash and the user takes the bread. In this example, sale recovery program 201 determines that the user has purchased bread and stores this information in purchase database 234. In an embodiment, sale recovery program 201 determines one or more purchase patterns of a consumer. For example, sale recovery program 201 determines a user purchases dog food once a month. In an embodiment, sale recovery program 201 stores determined purchase patterns in purchase database 234. In an embodiment, sale recovery program 201 determines an item was purchased if a user who resides with another user purchases an item. For example, if sale recovery program 201 determines user A was at the physical store looking at cameras and the next day user B who lives with user A orders a camera online, sale recovery program 201 stores this information in purchase database 234.

In an embodiment, sale recovery database 236 includes information on recovered sales and replacement items. In an embodiment, a recovered sale is a sale or product that the user originally did not purchase but later purchased either the same product or a replacement item. For example, if user was online searching for pillows to buy but does not purchase any online but ends up purchasing a pillow from the store the next day, the pillow purchased at the store is the recovered sale. In another example, sale recovery program 201 determines the user is shopping in a store and puts a pair of jeans in their cart. Sale recovery program 201 further determines the user does not purchase the jeans in store. Here, sale recovery program 201 determines a replacement item for a pair of jeans from another designer. Sale recovery program 201 displays the replacement item to the user and user purchases the replacement item jeans. Sale recovery program 201 stores information on both the replacement item and recovered sale in sale recovery database 236. In an embodiment, sale recovery database 236 stores information on substitute items that are acceptable to a particular consumer. For example, if a consumer prefers paper towel brand A, but the physical store is out of paper towel brand A, sale recovery program 201 determines paper towel brand B is a comparable item and stores this information in sale recovery database 236. In an embodiment, sale recovery database 236 stores information on the past, present, and future prices, discounts, or sales for items. In an embodiment, sale recovery program 201 accesses sale recovery database 236 to determine the price of an item to propose the user to recover a sale. For example, sale recovery program 201 determines substitute item A for a consumer and accesses sale recovery database 236 to determine the current price of substitute item A at store S is $20 but will be on sale for $15 next week. In an embodiment, sale recovery database 236 includes information on the physical layout of a store. For example, sale recovery program 201 determines a recovery item to propose to the user while the user is in the store and accesses sale recovery database 236 to navigate the user to the recovery item within the store.

In an embodiment, sale recovery program 201 generates a list of one or more items and stores the list in sale recovery database 236. In an embodiment, the generated list includes proposed replacement items. For example, sale recovery program 201 determines a consumer typically purchases soap brand B and sale recovery program 101 generates a list of one or more replacement items such as soap brand C and soap brand D.

In an embodiment, sale recovery policies 238 include a dynamic set of rules for recommending an item to a user in attempt to recover a sale based on information included in consumer profile database 232, purchase database 234, sale recovery database 236, and external environment factors. External environment factors can include, but are not limited to, one or more of the current location of the user, who else the user is with, customer reviews of the product, who the user lives with, what items another person the user is with is purchasing, time of day, day of the week, or time of the year. For example, if user A lives with user B and user B purchases a vacuum, user A likely will not need to also buy a vacuum cleaner. In another example, a consumer may be more inclined to purchase an item depending on the time of day, such as being more inclined to purchase a cup of coffee in the morning than at night.

In an embodiment, the sale recovery policies 238 includes information describing different decision-making actions sale recovery program 201 should perform depending on the particular item, information included in consumer profile database 232, purchase database 234, sale recovery database 236, and the surrounding environment in which the user is in, such as a need by date. For example, the selected policy and decision making action in the policy can be dependent on, but not limited to, one or more of the derived reason of loss of sale purchase history, calendar and need-by date, user preferences having substitution preferences (preference on item and color), social media (e.g., customer looking for an option in the Facebook post customer made an hour ago), recently accessed product reviews, recent searches over sales consumer channels or an integrated virtual assistants. In an embodiment, policy decision-making actions can be dependent on the current location or consumer channel of retail of a user, such as if the user is in a physical store or home online shopping.

In an embodiment, sale recovery policies 238 prioritize items based on various criteria. For example, a product gets prioritized include the customer's need date (e.g., a book is needed before school commencement), sale events on the marketplace (e.g., a sale will start next week, and the product's price will meet customer preferences), upcoming calendar events such as birthday or other holiday. In an embodiment, sale recovery program 201 prioritizes a list of one or more proposed replacement items in sale recovery database 236 based on the selected policy from sale recovery policies 238. For example, if the selected policy indicates to propose brand B over brand C based on a sale or shipping timeline, sale recovery program 201 prioritizes brand B over brand C on the list of proposed placement items.

In an embodiment, AR device 250 an augmented reality headset or other augmented reality device capable of displaying real world and augmented reality objects. In an embodiment, AR device 250 is an IoT enabled system which can include a wearable device, head mounted AR glass, cap, electronic cloth based dress, shoes etc. IoT enabled devices are generating events when any criteria or condition is met. For example, if more than one AR device or sensor is connected to network 240 and collecting information and monitoring the users movement. For example, AR device 250 collects information of the users surrounding ands items the user picks up. In an embodiment, various IoT devices can be involved, such as IoT device 260 in which some of the IoT devices can be wearable devices and some IoT devices can be IoT devices located external to an individual. In an embodiment, both AR device 250 and IoT device 260 monitor a user's activity. For example, AR device 250 and IoT device 260 monitor a user walking through a grocery store, put items in a cart, and cash out at the cash register. In an embodiment, sale recovery program 201 displays proposed items in the users field of view on AR device 250. For example, if sale recovery program 201 determines a proposed item for a consumer, sale recovery program 201 displays the proposed item in the users field of view on AR device 250. In an embodiment, sale recovery program 201 displays directional guidance in the users field of view on AR device 250 to a proposed item. For example, if sale recovery program 201 determines a proposed item for a consumer, sale recovery program 201 displays the directional guidance to the user to the proposed item in the users field of view on AR device 250. In an embodiment, network computing environment 200 includes multiple AR devices 250. In an embodiment AR device 250 and IoT device 260 are a singular unit.

In an embodiment, sale recovery program 201 monitors a user's shopping activity across one or more consumer channels. In an embodiment, monitoring a user's shopping activity includes browser history, search history, application usage, purchase history, bank statement, credit card statement, order history, movement, verbal communication. In an embodiment, consumer channels include in person, physical stores, markets, online platforms, store applications, store websites, and any consumer channel capable of purchasing, returning, selling or trading items. In an embodiment, sale recovery program 201 dynamically updates user's purchases when a purchase is determined. For example, sale recovery program 201 monitors a user's shopping activity across one or more consumer channels and determines a purchase for a couch on the users credit card statement. In this example, sale recovery program 201 determines the user purchased a couch and dynamically updates the user's purchase history in purchase database 234.

In an embodiment, sale recovery program 201 monitors a user's shopping activity across one or more consumer channels to determine the user's shopping preferences. For example, sale recovery program 201 monitors a user's shopping activity to determine 80% of the time the user purchases home appliances from brand H and brand H home appliances are a preference.

In an embodiment, sale recovery program 201 monitors a user's shopping activity across one or more consumer channels to determine a primary item. In an embodiment, a primary item is an item the user has not yet purchased. In another example, sale recovery program 201 monitors a user's shopping activity to determine a user was browsing televisions in a brick and mortar store but did not purchase a television while in the store. Here, sale recovery program 201 determines a television is a primary item.

In an embodiment, sale recovery program 201 determines a loss of a sale. In an embodiment, sale recovery program 201 determines a loss of a sale by information included in, but not limited to, one or more of a user's browsing history, search history, online orders, order cancellations, gestures, in-store activities, purchase history, electronic communications, verbal communications, or physical actions. For example, sale recovery program 201 determines a loss of a sale when a user adds an item to their online cart and does not check out. For example, if a user adds coffee grounds to their online cart but does not checkout, sale recovery program 101 determines the coffee grounds are the item associated with the loss of sale. In another example, sale recovery program 201 determines a user verbally says “I'm not going to buy these paper towels today” while in the supermarket and holding paper towels.

In an embodiment, sale recovery program 201 determines a reason for the loss of a sale. In an embodiment, a reason for a loss of sale can include, but is not limited to, one or more of a change of mind of a consumer, inventory availability, shipping/fulfillment constraints, price range, deferred purchase due to some non-specific reasons, missed purchase (e.g. missed or forgot to buy in previous consumer channels). In an embodiment, a reason for a potential loss of sale includes, but is not limited to, one or more of a change of mind by a customer, inventory availability, shipping/fulfillment constraints, price range, deferred purchase due to some non-specific reasons, and missed purchase. For example, a user is in a supermarket in the paper towel aisle wearing AR device 250. In this example, recovery program 201 accesses consumer profile database 232 to determine this user prefers paper towel brand A. In this example, recovery program 201 accesses purchase database 234 to determine this user usually purchases paper towel brand A every 2 weeks and has not purchased any paper towels in the last 3 weeks. Here, recovery program 201 determines the supermarket is out of stock of paper towel brand A and thus the reason why the user did not buy any paper towels. In this example, recovery program 201 determines the reason for the loss sale is lack of inventory.

In an embodiment, sale recovery program 201 determines a date or time that an item needs to be purchased by. In an embodiment, a time constraint includes, but is not limited to, one or more of when an item needs to be shipped by in order to be received in time, when a consumer will run out of a product, or the date of an event an item is required for. For example, sale recovery program 201 determines the user is hosting a birthday party on Wednesday July 6^{th} and needs a cake for the birthday party. Sale recovery program 201 determines the user either needs to buy baking supplies for a cake or purchase a premade cake by Wednesday July 6^{th}. Meaning, the user does not have a need for a cake after Wednesday July 6^{th}. In another example, sale recovery program 201 determines the user requires a 30 pack of vitamins every 30 days. Meaning, the user requires purchasing a 30 pack of vitamins at least every 30 days or the user will run out of vitamins.

In an embodiment, sale recovery program 201 determines the current inventory of an item for one or more consumer channels. For example, sale recovery program 201 determines shampoo brand A is out of stock in store S but is in stock on store S's web site. In an embodiment, sale recovery program 201 determines the delivery time for an item. For example, sale recovery program 201 determines shampoo A can be delivered to a user's home in 2 days.

In an embodiment, sale recovery program 201 determines the current inventory of a replacement item. In an embodiment, a replacement item is an item similar to the original item. In an embodiment, sale recovery program 201 determines a replacement item by selecting a policy from sale recovery policies 238. For example, user needs balloons for a party by August 8^{th}. In this example, sale recovery program 201 determines a replacement item by selecting a policy to determine a replacement item for balloons to be delivered to the user by August 8^{th}.

In an embodiment, sale recovery program 201 determines a proposed replacement item. In an embodiment, sale recovery program 201 determines a proposed replacement item indicated by a selected policy.

In an embodiment, sale recovery program 201 determines directional guidance to the proposed replacement item. In an embodiment, directional guidance includes various methods not limited to audio instructions, augmented product information by enhancing row-aisle details, directing using arrows, store-bot and color-coded lights (e.g., green to exact match item, blue to substitute item, etc.).

In an embodiment, sale recovery program 201 determines an item or replacement item was purchased and updates consumer profile database 232 and purchase database 234. Accordingly, if a user purchases detergent, sale recovery program 201 updates purchase database 234 to include information detergent was recently purchased and that the user likely does not need to purchase detergent in the near future. In another example, if sale recovery program 201 proposes brand D detergent as a replacement item to user, user purchases brand D detergent, and sale recovery program receives information that user liked brand D detergent, sale recovery program 201 updates consumer profile database 232 to include information that the user prefers brand D detergent.

In an embodiment, sale recovery program 201 utilizes deep learning techniques on visual data, where visual data can be captured by either the camera of AR device 250 and/or on or more IoT devices 260 at a physical consumer channel. In an embodiment, sale recovery program 201 utilizes clustering techniques like K-means clustering to detect a viewed-item or item being viewed. K-means clustering is a method of vector quantization, originally from signal processing, that aims to partition n observations into k clusters in which each observation belongs to the cluster with the nearest mean, serving as a prototype of the cluster. In an embodiment, sale recovery program 201 assures detection of an item through the correlation with the exact location. For example, at a superstore, if a customer is looking at a product at a 50% off location, then, if the visuals indicate that it is a packed box, system can determine it to be item XYZ because 50% off is running only one packed box item which is XYZ.

In an example, sale recovery program 201 determines Amit's browser history and determines Amit was browsing for a D-SLR camera on a leading electronic retailer's website. Sale recovery program 201 determines this product was available in 3 variants priced at different price points. Sale recovery program 201 determines on the retailer's website, the mid variant of the D-SLR camera was out of stock and. Amit did not purchase a D-SLR camera online. Here, sale recovery program 201 determines a sale of a D-SLR camera was lost due to lack of inventory. Later in the week, IoT devices capture Amit's movement and sale recovery program 201 determines Amit is visiting the store to buy a charger while wearing AR head gear. Sale recovery program 201 determines Amit has still not purchased a D-SLR camera and a mid-variant of the D-SLR camera is in stock in the same store Amit is in to buy the charger. While Amit is passing through the aisle in camera section, sale recovery program 201 displays guided navigation by showing arrow in the AR head gear field of view to the mid variant D-SLR camera. Upon accepting this navigation, sale recovery program 201 displays in the AR head gear field of view Amit's activity along with the reason why he did not buy the product online. Sale recovery program 201 also displays in the AR head gear field of view comparative market price of D-SLR camera along with relevant reviews. Amit purchases the mid variant D-SLR camera and charger. Sale recovery program 201 adds mid variant D-SLR camera and charger to purchase database 234.

In another example, Rita and Roger reside in the same household. Rita gives an extensive list of items for upcoming Holiday event to Roger. IoT devices capture Roger's movement to determine Roger is in the physical store to buy these products. Rita had forgotten to add “spectacles” as a gift for her parents which she needs before the Holiday event. IoT device 260 captured verbal data and sale recovery program 201 determined that Rita had verbally discussed about the need to purchase spectacles as gifts for Rita's parents to Roger. Sale recovery program 201 determined Rita continued to search for spectacles online and left retailers' website because she could not find the particular preferred brand and model. Sale recovery program 201 determines a lost sale of spectacles based on unavailability of brand and model. Sale recovery program 201 determines the spectacles are needed by the Holiday event and are currently in stock in a preferred brand and model at the physical store Roger is shopping at. While shopping at the physical store with AR glasses, sale recovery program 201 displays navigational guidance using the AR glasses to the location of the preferred spectacles in the store.

In another example, IoT device captures information and sale recovery program 201 determines Tom visits a technology store to buy a storage drive. IoT device 260 captures information and sale recovery program 201 determines Tom explores two options but doesn't buy anything. Later, IoT device 260 captures information and sale recovery program 201 determines Tom visits the technology stores website to browse televisions. Here, sale recovery program 201 displays an advertisement for a storage drive which includes more storage than the two options viewed in store and a personalized offer for 15% discount.

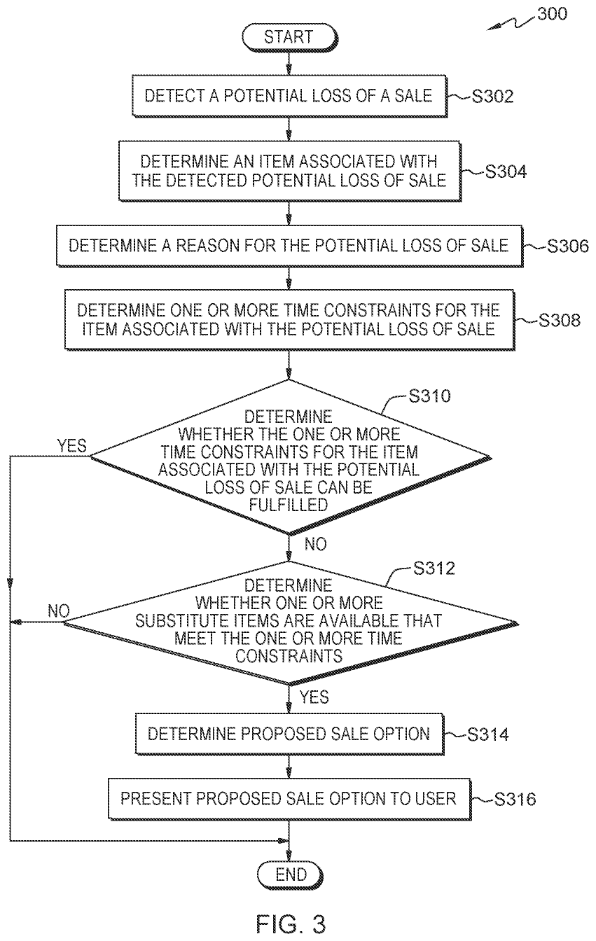

FIG. 3 is a flow chart diagram depicting operational steps for sale recovery program 201, generally designated 300, in accordance with at least one embodiment of the present invention. FIG. 3 provides only an illustration of one implementation and does not imply any limitations with regard to the environments in which different embodiments may be implemented. Many modifications to the depicted environment may be made by those skilled in the art without departing from the scope of the invention as recited by the claims.

At step S302, sale recovery program 201 detects a potential loss of a sale. In an embodiment, a potential loss of sale includes a user visiting a store or website and not purchasing an item.

At step S304, sale recovery program 201 determines an item associated with the detected potential loss of sale.

At step S306, sale recovery program 201 determines a reason for the potential loss of sale.

At step S308, sale recovery program 201 determines one or more time constraints for the item associated with the potential loss of sale. For example, a time constraint includes, but is not limited to, one or more of when an item needs to be shipped be in order to be received in time, when a consumer will run out of a product, or the date of an event an item is required for.

At decision step S310, sale recovery program 201 determines whether the one or more time constraints for the item associated with the potential loss of sale can be fulfilled. For example, if an item is needed by August 15^{th} and today is August 18^{th}, the date of the item required by has passed. However, if an item is needed by August 15^{th} and today is August 3^{rd}, the date of the item required by has not passed. If sale recovery program 201 determines the date item required by has not passed (decision step S310 “NO” branch), sale recovery program 201 proceeds to step S312. If recovery program 201 determines the date item required by has passed (decision step S310 “YES” branch), sale recovery program 201 ends.

At step S312, sale recovery program 201 determines whether one or more substitute items are available that meet the one or more time constraints. If sale recovery program 201 determines no substitute items are available that meet the one or more time constraints (decision step S312 “NO” branch), sale recovery program 201 ends. If recovery program 201 determines one or more substitute items are available that meet the one or more time constraints (decision step S312 “YES” branch), sale recovery program 201 proceeds to step S314.

At step S314, sale recovery program 201 determines a proposed sale option. In an embodiment, sale recovery program 201 selects a policy for a proposed sale option which is based, at least in part, on inventory, need by date, price, user preferences, and shipping timeline. In an embodiment, sale recovery program 201 determines a discount for the proposed sale option item.

At step S316, sale recovery program 201 presents proposed sale options to user. In an embodiment, sale recovery program 201 presents proposed sale options to user by directional guidance, a visual representation of the item, or a promotion on user device or AR device.

What is claimed is:

1. A computer-implemented method for resolving a potential loss of sale, the computer-implemented method comprising:
determining a potential lost sale and an item associated with the potential lost sale;
determining a reason for the potential lost sale of the item;
determining one or more substitute items for the item based, at least in part, on the determined reason for the potential lost sale of the item; and
presenting the one or more determined substitute items to a user.

2. The computer-implemented method of claim 1, wherein determining one or more substitute items for the item is further based on:
determining one or more time constraints for the item associated with the potential lost sale; and
determining the one or more substitute items meet the one or more time constraints for the item associated with the lost sale.

3. The computer-implemented method of claim 1, wherein determining the reason for the potential lost sale of the item is based, at least in part, on information selected from the group consisting of:
browsing history, search history, online orders, order cancellations, gestures, in-store activities, purchase history, electronic communications, the user's verbal communications, and the user's physical actions.

4. The computer-implemented method of claim 1, wherein determining the one or more substitute items is further based on:
monitoring the user's shopping activity across one or more consumer channels;
determining one or more of the user's shopping preferences based on the user's shopping activity; and
determining one or more substitute items based, at least in part, on the user's shopping preferences.

5. The computer-implemented method of claim 1, further comprising:
determining directional guidance to the one or more substitute items; and
displaying the directional guidance to the one or more substitute items to the user.

6. The computer-implemented method of claim 1, wherein determining the one or more substitute items is further based on:
determining a current inventory of the one or more substitute items; and
determining the substitute item is in stock.

7. The computer-implemented method of claim 1, wherein the determined reason for the potential lost sale of the item includes one or more of a change of mind of the user, inventory availability, shipping constraints, fulfillment constraints, price range, deferred purchase, or missed purchase.

8. A computer program product for resolving a potential loss of sale, the computer program product comprising one or more computer readable storage media and program instructions stored on the one or more computer readable storage media, the program instructions including instructions to:
determine a potential lost sale and an item associated with the potential lost sale;
determine a reason for the potential lost sale of the item;
determine one or more substitute items for the item based, at least in part, on the determined reason for the potential lost sale of the item; and
present the one or more determined substitute items to a user.

9. The computer program product of claim 8, wherein the instructions to determine one or more substitute items for the item is further based on instructions to:
determine one or more time constraints for the item associated with the potential lost sale; and
determine the one or more substitute items meet the one or more time constraints for the item associated with the lost sale.

10. The computer program product of claim 8, wherein determining the reason for the potential lost sale of the item is based, at least in part, on information selected from the group consisting of:
browsing history, search history, online orders, order cancellations, gestures, in-store activities, purchase history, electronic communications, the user's verbal communications, and the user's physical actions.

11. The computer program product of claim 8, wherein the instructions to determine the one or more substitute items is further based on instructions to:
monitor the user's shopping activity across one or more consumer channels;
determine one or more of the user's shopping preferences based on the user's shopping activity; and
determine one or more substitute items based, at least in part, on the user's shopping preferences.

12. The computer program product of claim 8, further comprising instructions to:
determine directional guidance to the one or more substitute items; and
display the directional guidance to the one or more substitute items to the user.

13. The computer program product of claim 8, wherein the instructions to determine the one or more substitute items is further based on instructions to:
determine a current inventory of the one or more substitute items; and
determine the substitute item is in stock.

14. The computer program product of claim 8, wherein the determined reason for the potential lost sale of the item includes one or more of a change of mind of the user, inventory availability, shipping constraints, fulfillment constraints, price range, deferred purchase, or missed purchase.

15. A computer system for resolving a potential loss of sale, comprising:
one or more computer processors;
one or more computer readable storage media;
computer program instructions;
the computer program instructions being stored on the one or more computer readable storage media for execution by the one or more computer processors; and
the computer program instructions including instructions to:
determine a potential lost sale and an item associated with the potential lost sale;
determine a reason for the potential lost sale of the item;
determine one or more substitute items for the item based, at least in part, on the determined reason for the potential lost sale of the item; and
present the one or more determined substitute items to a user.

16. The computer system of claim 15, wherein the instructions to determine one or more substitute items for the item is further based on instructions to:
determine one or more time constraints for the item associated with the potential lost sale; and
determine the one or more substitute items meet the one or more time constraints for the item associated with the lost sale.

17. The computer system of claim 15, wherein determining the reason for the potential lost sale of the item is based, at least in part, on information selected from the group consisting of:
browsing history, search history, online orders, order cancellations, gestures, in-store activities, purchase history, electronic communications, the user's verbal communications, and the user's physical actions.

18. The computer system of claim 15, wherein the instructions to determine the one or more substitute items is further based on instructions to:
monitor the user's shopping activity across one or more consumer channels;
determine one or more of the user's shopping preferences based on the user's shopping activity; and
determine one or more substitute items based, at least in part, on the user's shopping preferences.

19. The computer system of claim 15, further comprising instructions to:
determine directional guidance to the one or more substitute items; and
display the directional guidance to the one or more substitute items to the user.

20. The computer system of claim 15, wherein the determined reason for the potential lost sale of the item includes one or more of a change of mind of the user, inventory availability, shipping constraints, fulfillment constraints, price range, deferred purchase, or missed purchase.
